(19) United States
(12) Patent Application Publication
(10) Pub. No.: US 2016/0035212 A1
(43) Pub. Date: Feb. 4, 2016

(54) Location system for a misplaced item

(71) Applicant: Michael Gorzelic, Orefiled, PA (US)

(72) Inventor: Michael Gorzelic, Orefiled, PA (US)

(21) Appl. No.: 14/811,828

(22) Filed: Jul. 29, 2015

Related U.S. Application Data
(60) Provisional application No. 62/030,591, filed on Jul. 29, 2014.

(51) Int. Cl. G08B 21/24; H04W 68/00

(52) U.S. Cl. CPC G08B 21/24; H04W 68/00

(57) ABSTRACT

A mechanical or capacitive switch and an illuminated button are provided on the exterior surface of a control unit comprises a location system for a misplaced item. The switch selects whether an audible beacon, a visible beacon, or both will be provided, and the button pages a beacon unit when pressed. A wireless paging signal is generated from the control unit, and the beacon unit has the capability to receive the paging signal. In response, the beacon unit emits an audible or visible signal to enable the user to locate it. The beacon unit is provided as a wallet-sized card which may be easily attached to a remote control or a set of car keys, or inserted into a wallet or purse.

### CROSS-REFERENCE TO RELATED APPLICATIONS

This Application claims the benefit of U.S. Provisional Application No. 62/030591, filed Jul. 29, 2014, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to accessories for electronic devices, and in particular to a location system for misplaced items. The loss of a wallet, purse, key, or a television remote control is a frequent and annoying event in many households. These items can be found in odd places such as under a recliner or wedged between the cushions of a couch, or it may have been placed out of reach of a curious toddler, ending up in a completely new and creative location which the user may later forget. A location system for a remote control and other items, which causes an audible or visual signal to be emitted from the remote control when a button on a control unit is pressed, will resolve this problem.

### SUMMARY OF THE INVENTION

Accordingly, the invention is directed to a location system for a misplaced item. A mechanical or capacitive switch and an illuminated button are provided on the exterior surface of a control unit. The switch selects whether an audible beacon, a visible beacon, or both will be provided, and the button pages a beacon unit when pressed. A wireless paging signal is generated from the control unit, and the beacon unit has the capability to receive the paging signal. In response, the beacon unit emits an audible or visible signal to enable the user to locate it. The beacon unit is provided as a wallet-sized card which may be easily attached to a remote control or a set of car keys, or inserted into a wallet or purse.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a side view of the control unit of the first exemplary embodiment, displaying the control unit 10, the prongs 10A, the button 11, and the switch 12.

FIG. 2 is a front view of the control unit of the first exemplary embodiment, displaying the control unit 10, the button 11, and the switch 12.

FIG. 3 is a top view of the beacon unit of the first exemplary embodiment configured as a keychain attachment, displaying the beacon unit 13, the LED 14, the speaker 15, the grommet 16, and the loop 16A.

FIG. 4 is a side view of the beacon unit of the first exemplary embodiment, displaying the beacon unit 13, the front surface 13A, the speaker 15, and the fasteners 17.

FIG. 5 is a top view of the beacon unit of the first exemplary embodiment configured as a wallet card, displaying the beacon unit 13, the LED 14, and the speaker 15.

FIG. 6 is a front perspective transparency view of a purse with the beacon unit of the first exemplary embodiment inserted, and a front view of a smartphone with the beacon unit of the first exemplary embodiment attached, displaying the beacon unit 13, the purse 17, and the smartphone 18.

FIG. 7 is a front view of a remote control with the beacon unit of the first exemplary embodiment attached, displaying the beacon unit 13, and the remote control 19.

FIG. 8 is a front perspective transparency view of a wallet with the beacon unit of the first exemplary embodiment inserted, displaying the beacon unit 13, and the wallet 20.

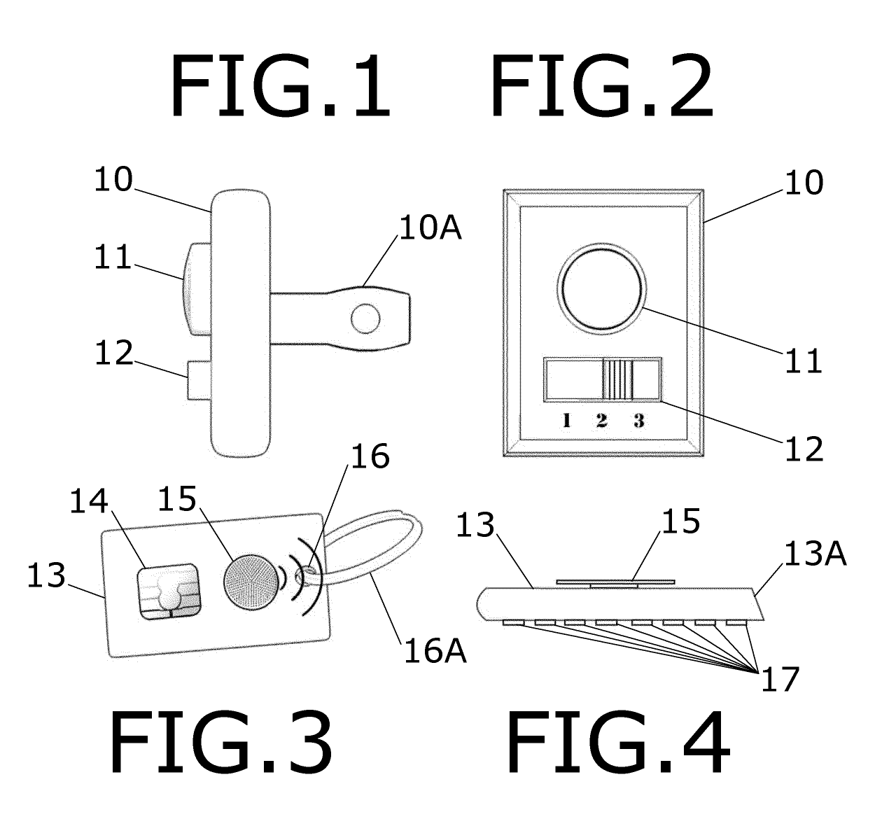

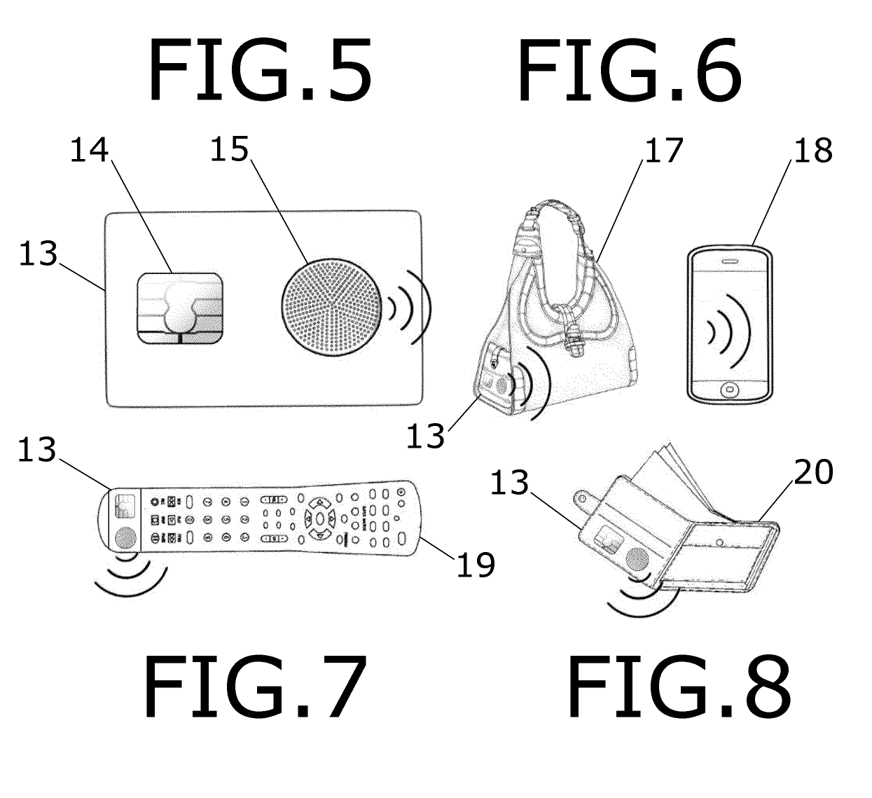

### DETAILED DESCRIPTION OF THE INVENTION

Referring now to the invention in more detail, the invention is directed to a location system for a misplaced item. A mechanical or capacitive switch 12 and an illuminated button 11 are provided on the exterior surface of a control unit 10. The switch 12 selects whether an audible beacon, a visible beacon, or both will be provided, and the button 11 pages a beacon unit 13 when pressed. A wireless paging signal is generated from the control unit 10, and the beacon unit 13 has the capability to receive the paging signal. In response, the beacon unit 13 emits an audible or visible signal, or both, to enable the user to locate it. The beacon unit 13 is provided as a wallet-sized card which may be easily attached to a remote control 19 or a set of car keys, or inserted into a wallet 20 or purse 17.

It is to be understood that while the invention is intended for use with a purse 17, smartphone 18, remote control 19, key ring, wallet, mobile phone, or other item which is small and easily lost; this is not intended as a limitation. With suitable modifications, the invention may be used as a location system for any object to which a beacon unit 13 may be affixed or attached. The invention provides a beacon unit 13 which is large enough to house sufficiently powerful batteries and other electronic components for an extended range and service life, enabling the user to employ the system in many applications.

The first exemplary embodiment is intended for user installation as an after-market modification. An alternate embodiment, wherein the beacon unit 13 is intended for installation as original equipment by the manufacturers of smartphones 18, remote controls 19, wallets, key rings, purses, and other items, is also contemplated, and such items may be promoted according to a common mark identifier designating compatibility with a transmitter according to the present invention. Such an alternate embodiment may provide an external battery-powered module for the control unit 10, which may be affixed to the exterior surface of the television with hook-and-loop fasteners, adhesive, or a similar fastener. Such a module may be detached for use in locating the beacon unit 13 in the various rooms of the user's residence, in the user's vehicle, in other interior locations, or outdoors.

The first exemplary embodiment comprises a control unit 10, which is powered by standard 120-volt household current and intended for installation on a standard two-pronged or three-pronged wall outlet, and a beacon unit 13 which is powered by one or more replaceable batteries. The rear surface of the control unit 10 provides two prongs 10A for insertion into the wall outlet. The control unit 10 may provide a plurality of user-selectable channels accessible, for example, via a multi-position switch, each configured to address a particular beacon unit 13, affixed to or built into a particular device or object. A hand-writable register may be affixed to the exterior of the control unit 10 wherein the user may log the designation of provided channels to objects for later reference. Further, the control unit 10 may be configured to communicate with a mobile data device, for example a smartphone or tablet to enable remote control paging of the designated items

The beacon unit 13 provides a flashing light-emitting diode (LED) 14 and a small speaker 15 on its top surface, with a front surface 13A which is smooth and sloped to enable easy insertion into a wallet 20, pocket, or similar storage space. The beacon unit 13 also provides an on/off switch on its bottom surface, and is preferably provided in two versions. The keychain attachment version provides a grommet 16 at one end with an attached flexible loop 16A, enabling the user to easily attach it to a key ring, the handle of a briefcase or suitcase, the shoulder strap of a backpack, or a similar item. The wallet card version is provided in a suitable size and shape such that the user may easily insert it into a purse 17, wallet 20, or similar item.

Either version may be affixed to the front or rear surface of a smartphone 18, remote control 19, or similar item, using hook-and-loop fastener strips or other fasteners 17 which are provided. Multiple beacon units 13, protecting multiple items, may be employed with the same control unit 10 and are available separately.

Electronic components of the control unit 10 include a radio frequency (RF) transmitter, an internal antenna, an illuminated button 11, and a three-way switch 12. Electronic components of the beacon unit 13 include a RF receiver, an internal antenna, an on/off switch, an LED 14, and a speaker 15. Alternative wireless communication means may be provided, for example beacon signals may be transmitted over local Bluetooth™ or Wi-Fi™ protocols, and longer range signaling may be achieved via mobile data networks and a remote data transmission service, for example the Internet. Further, RF, Bluetooth™, Wi-Fi™, and mobile data signals may be analyzed to localize a beacon unit 13, and the beacon unit 13 may be configured to determine its own location based on similar telemetry or readings taken from the Global Positioning System (GPS), and such localization information may be transmitted back to the control unit 10 for display or transmitted on to the user via a mobile data device.

To use the first exemplary embodiment, the user inserts the prongs 10A of the control unit 10 into a wall outlet. This causes the button 11 to become illuminated, indicating that the control unit 10 is activated. The illumination of the button 11 preferably provides a soft glow, which is suitable for use as a night light. The user may then activate the beacon unit 13 with the on/off switch provided on the bottom surface. Finally, the user inserts the beacon unit 13 in a purse 17, wallet 20, or similar item, attaches the beacon unit 13 to a key ring or similar item using the loop 15A which is provided, or affixes the beacon unit 13 to a smartphone 18, remote control 19, or similar item, optionally using the fasteners 17 which are provided.

If the item bearing the beacon unit 13 becomes lost, the user selects whether an audible beacon, visible beacon, or both is desired using the switch 12 provided, and presses the illuminated button 11. This causes the button 11 to flash, indicating that a paging signal is being sent. The type of paging signal governs whether the beacon unit 13 will respond with an audible beacon, visible beacon, or both. When the paging signal is received by the beacon unit 13, it causes emission of an audible signal from the speaker 15, a flashing visual signal from the LED 14, or both. Upon recovering the beacon unit 13 and the item bearing it, the user may press the button 11 again, deactivating the paging signal and restoring the illumination of the button 11 to its non-flashing state. When the paging signal is no longer transmitted, the beacon unit 13 no longer emits the beacon.

The control unit 10, the prongs 10A, the button 11, the switch 12, the beacon nit 13, the LED 14, the speaker 15, and the grommet 16 are preferably manufactured from durable, rigid materials, such as steel, aluminum alloy, copper alloy, brass, and plastic. The loop 16A is preferably manufactured from a flexible, durable material such as plastic or nylon webbing. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A location system for misplaced items, comprising:
(a) a control unit having the capacity to send a wireless paging signal;
(b) one or more beacon units having the capacity to receive said wireless paging signal;
Wherein said control unit sends said wireless paging signal to said one or more beacon units causing said beacon unit to emit a signal.
